(19) United States
(12) Patent Application Publication
(10) Pub. No.: US 2025/0257783 A1
(43) Pub. Date: Aug. 14, 2025

(54) SHOCK BODY HAVING RAISED COOLING PATTERN ON AN EXTERIOR OF A CYLINDER

(71) Applicant: Fundamental Motorsports, LLC, Long Beach, CA (US)

(72) Inventor: Michael J. Torre, Long Beach, CA (US)

(21) Appl. No.: 19/048,657

(22) Filed: Feb. 7, 2025

Related U.S. Application Data
(60) Provisional application No. 63/551,492, filed on Feb. 8, 2024.

(51) Int. Cl. F16F 9/42; F16F 9/16; F16F 9/50

(52) U.S. Cl. CPC F16F 9/42; F16F 9/16; F16F 9/50; F16F 2222/12; F16F 2238/026

(57) ABSTRACT

A shock absorber body assembly is disclosed that is includes a shock body formed of a cylinder defining a top cylinder end and a bottom cylinder end, and having a cylinder wall that surrounds a cylinder cavity. The cylinder wall is defined by a solid interior portion and a raised cooling pattern disposed on and proud of an exterior side of cylinder wall. The raised cooling pattern is comprised of one or more fins, wherein the raised cooling pattern is configured to provide for heat transfer from hydraulic fluid within the cavity of the cylinder cavity to an environment external to the shock absorber body assembly. The raised cooling pattern includes one or more cooling fins that extend along a length of the cylinder in a straight line and extend outwardly from the cylinder wall in an orthogonal direction, a cooling lattice mesh, or a cooling gyroid mesh.

### CROSS-REFERENCE TO RELATED APPLICATIONS

This application claims priority to U.S. provisional application 63/551,492, filed Feb. 8, 2024, the entire contents of which are incorporated herein by reference.

### TECHNICAL FIELD

The disclosure relates generally to additive manufacturing and in particular to the designing and manufacturing of shock absorbers.

### BACKGROUND

The cost of manufacturing mechanical equipment and devices is strongly proportional to the number of components that are assembled together. The manufacturing, acquiring, managing, handling, and storing of multiple components can in some instances contribute significantly to the cost of production, and the greater complexity arising from assembling multiple components together can lead to errors in the manufacturing process. The cost of manufacturing mechanical equipment and devices is also proportional to the quantity of material involved. Furthermore, constraints relating to the allowable size of mechanical equipment and devices can hinder their design, limiting their performance. Aspects of the manufacturing process can also limit the performance of completed mechanical equipment and devices. For example, welding external assemblies to a device can add significant mass and increase the overall number of components, raising the likelihood of cracks, leaks, and breakages.

Shock absorbers encounter various instances of the problems described above. For example, shock absorbers typically have size constraints corresponding to particular spaces within vehicles in which they are installed. These size constraints can limit the shock absorber's design, restricting the possible performance of the shock absorber. Many shock absorbers degrade in performance or even fail due to the wearing down of components, especially welded components, or the leaking or overheating of hydraulic fluid. Also, when in use, many shock absorbers are too stiff for less forceful impacts and too soft for more forceful impacts.

### SUMMARY

Disclosed herein is shock absorber body assembly that, according to some embodiments, includes a shock body with a cylinder that defines a top cylinder end and a bottom cylinder end, and a plurality of fluid pathways extending along an exterior of the cylinder. According to some embodiments, each fluid pathway of the plurality of fluid pathways defines a respective first end of the fluid pathway in fluid communication with a top portion of the cylinder and a respective second end of the fluid pathway in fluid communication with a bottom portion of the cylinder. According to some embodiments, the plurality of fluid pathways comprises a first fluid pathway and a second fluid pathway. According to some embodiments, the first fluid pathway and the second fluid pathway have differing lengths or positions lengthwise along the exterior of the cylinder. According to some embodiments, the shock body includes only a single component.

According to alternative embodiments, a shock absorber body assembly, is disclosed that comprises a shock body, comprising a cylinder defining a top cylinder end and bottom cylinder end, and a first fluid pathway extending along an exterior of the cylinder, wherein the first fluid pathway defines a first end of the first fluid pathway in fluid communication with a top portion of the cylinder and a respective second end of the first fluid pathway in fluid communication with a bottom portion of the cylinder.

In some embodiments, the shock body is formed via a material additive manufacturing process. In some embodiments, the shock body is formed of a single material. In some embodiments, the plurality of fluid pathways are regularly spaced around the exterior of the cylinder.

In some embodiments, at least one fluid pathway of the plurality of fluid pathways includes a check valve disposed in line with the first fluid pathway, the check valve configured to allow hydraulic fluid flow in a first direction between the top and bottom portions of the cylinder and prevent hydraulic fluid flow in a second direction between the top and bottom portions of the cylinder, the second direction opposite the first direction.

In some embodiments, the shock body further comprises an adjustable fluid pathway, the adjustable fluid pathway comprising an adjustable valve disposed in line with the adjustable fluid pathway, the adjustable valve configured to adjustably limit hydraulic fluid flow along the adjustable fluid pathway between the top and bottom portions of the cylinder.

In some embodiments, the plurality of fluid pathways includes at least four fluid pathways. In some embodiments, the plurality of fluid pathways are at least partially proud of the exterior of the cylinder (e.g., protrudes beyond an adjacent surface). In some embodiments, the shock body further comprises a raised cooling pattern proud of the exterior of the cylinder, where the raised cooling pattern comprises one or more of straight cooling fins, curved cooling fins, a cooling lattice mesh, and a cooling gyroid mesh. In some embodiments, a thickness of a wall of the cylinder, including the raised cooling pattern, does not exceed 0.125 inches. In some embodiments, the thickness of the wall of the cylinder, excluding the raised cooling pattern, is within a range of 0.508-1.27 mm (0.02-0.05 inches) with one specific embodiment being a thickness of 0.762 mm (0.03 inches). In some embodiments, the thickness of the raised cooling pattern is within a range of 1.905-3.175 mm (0.075-0.125 inches).

In some embodiments, the cylinder forms a cavity that is configured to be partially filled with a hydraulic fluid, and wherein the first fluid pathway is configured to receive hydraulic fluid during operation of the shock absorber body assembly.

In some embodiments, the shock body further comprises a reservoir in fluid communication with the cylinder. In some embodiments, the cylinder and the reservoir are separated by a cooling bridge comprising a cooling lattice mesh or a cooling gyroid mesh. In some embodiments, the shock absorber body assembly further comprises a coil spring enwrapping the cylinder. In some embodiments, one or more of the cylinder and the reservoir comprises a raised cooling pattern, where the raised cooling pattern comprises one or more of straight cooling fins, curved cooling fins, a cooling lattice mesh, and a cooling gyroid mesh.

In some embodiments, the shock absorber body assembly further comprises a body cap defining a top closure of the cylinder. In some embodiments, the body cap comprises an attachment member configured to operably attach the shock absorber body assembly to a vehicle.

Also disclosed herein is shock absorber that, according to some embodiments, includes a shock body with a cylinder defining a top cylinder end and a bottom cylinder end, where the cylinder is filled with a hydraulic fluid. The shock body also includes a reservoir defining a top reservoir end and bottom reservoir end, where the reservoir is in fluid communication with the cylinder, and the reservoir is partially filled with the hydraulic fluid and partially filled with a pressurized gas. The shock body also includes a body cap defining a top closure of the cylinder and the reservoir cavity. The shock body also includes a raised cooling pattern proud of an exterior of the cylinder and a plurality of fluid pathways extending along the exterior of the cylinder. Each fluid pathway of the plurality of fluid pathways defines a respective first end of the fluid pathway in fluid communication with a top portion of the cylinder and a respective second end of the fluid pathway in fluid communication with a bottom portion of the cylinder. The plurality of fluid pathways comprises a first fluid pathway and a second fluid pathway. The first fluid pathway and the second fluid pathway have differing lengths or positions lengthwise along the exterior of the cylinder. The shock absorber also includes a piston disposed within the cylinder, where the piston has a shaft extending through a bottom cylinder cap providing closure at the bottom cylinder end. The shock absorber also includes a reservoir cap defining a closure at the bottom reservoir end.

In some embodiments, the shock body of the shock absorber is formed of a single material via a material additive manufacturing process. In some embodiments, the cylinder and the reservoir of the shock absorber are separated by a cooling bridge comprising a cooling lattice mesh or a cooling gyroid mesh.

Also disclosed herein is s shock absorber body assembly, comprising a shock body, comprising a cylinder defining a top cylinder end and a bottom cylinder end, and having a cylinder wall that surrounds a cylinder cavity, wherein the cylinder wall is defined by a solid interior portion and a raised cooling pattern disposed on and proud of an exterior side of cylinder wall, wherein the raised cooling pattern is comprised of one or more fins, wherein the raised cooling pattern is configured to provide for heat transfer from hydraulic fluid within the cavity of the cylinder cavity to an environment external to the shock absorber body assembly.

In some embodiments, the raised cooling pattern comprises one or more cooling fins that extend along a length of the cylinder in a straight line and extend outwardly from the cylinder wall in an orthogonal direction. In some embodiments, the raised cooling pattern comprises a cooling lattice mesh or a cooling gyroid mesh. In some embodiments, a thickness of the solid interior portion of the cylinder wall is within a range of 0.508-1.27 mm. In some embodiments, a thickness of the raised cooling pattern is within a range of 1.905-3.175 mm. In some embodiments, a thickness of the cylinder wall, including the solid interior portion and the raised cooling pattern, does not exceed 3.175 mm.

In some embodiments, the shock body is formed via a material additive manufacturing process. In some embodiments, the shock body is formed of a single material. In some embodiments, the cylinder forms a cavity that is configured to be partially filled with a hydraulic fluid, and wherein the first fluid pathway is configured to receive hydraulic fluid during operation of the shock absorber body assembly. In some embodiments, the first fluid pathway includes a check valve, the check valve configured to allow hydraulic fluid flow in a first direction between the top portion of the cylinder and the bottom portion of the cylinder and prevent hydraulic fluid flow in a second direction between the top portion of the cylinder and the bottom portion of the cylinder, the second direction opposite the first direction.

In some embodiments, the shock body further comprises an adjustable fluid pathway, the adjustable fluid pathway comprising an adjustable valve disposed in line with the adjustable fluid pathway, the adjustable valve configured to adjustably limit hydraulic fluid flow along the adjustable fluid pathway between the top and bottom portions of the cylinder. In some embodiments, the shock body includes a plurality of fluid pathways including the first fluid pathway, wherein each of the plurality of fluid pathways extend along the exterior of the cylinder, and wherein each fluid pathway defines a respective first end of a respective fluid pathway in fluid communication with a top portion of the cylinder and a respective second end of a respective fluid pathway in fluid communication with a bottom portion of the cylinder. In some embodiments, the plurality of fluid pathways are at least partially proud of the exterior of the cylinder.

In some embodiments, the first fluid pathway and a second fluid pathway of the plurality of fluid pathways have differing lengths, differing positions lengthwise along the exterior of the cylinder, or differing cross-sectional areas. In some embodiments, the cylinder wall further includes at least a first fluid pathway extending along an exterior of the cylinder, wherein the first fluid pathway defines a first end of the first fluid pathway in fluid communication with a top portion of the cylinder and a respective second end of the first fluid pathway in fluid communication with a bottom portion of the cylinder, and wherein the first fluid pathway is at least partially proud of solid interior portion of the cylinder wall. In some embodiments, the shock body further comprises a reservoir in fluid communication with the cylinder.

In some embodiments, the reservoir comprises a second raised cooling pattern, wherein the second raised cooling pattern comprises one or more of straight cooling fins, curved cooling fins, a cooling lattice mesh, or a cooling gyroid mesh, wherein the second raised cooling pattern is configured to provide for heat transfer from the hydraulic fluid within a cavity of the reservoir cavity to the environment external to the shock absorber body assembly. In some embodiments, the shock absorber body assembly further comprises a coil spring enwrapping the cylinder. In some embodiments, the shock absorber body assembly further comprises a body cap defining a top closure of the cylinder. In some embodiments, the body cap comprises an attachment member configured to operably attach the shock absorber body assembly to a vehicle.

Also disclosed herein is a computer-implemented method for manufacturing a shock absorber body assembly that, according to some embodiments, includes generating a digital model of a shock absorber body assembly. The digital model includes a raised cooling pattern forming an exterior of a cylinder of the shock absorber body assembly. The method may further include performing a surface area analysis of the digital model, resulting in a surface area analysis dataset. The method may further include performing a thermal dissipation analysis of the digital model based on the surface area analysis dataset, resulting in a thermal dissipation analysis result. When the thermal dissipation analysis result indicates that the thermal dissipation satisfies a threshold comparison, the method may further include causing manufacture of the shock absorber body assembly including the raised cooling pattern. Manufacture of the shock absorber may be performed by an additive manufacturing printer to manufacture the shock absorber body assembly according to the digital model.

These and other features of the concepts provided herein will become more apparent to those of skill in the art in view of the accompanying drawings and following description, which describe particular embodiments of such concepts in greater detail.

### BRIEF DESCRIPTION OF THE DRAWINGS

Embodiments of the disclosure are illustrated by way of example and not by way of limitation in the figures of the accompanying drawings, in which like references indicate similar elements and in which:

FIG. 1 is a first perspective view of a shock body, in accordance with some embodiments.

FIG. 2 is a fluid schematic illustration of a shock absorber including the shock body of FIG. 1, in accordance with some embodiments.

FIG. 3 is a schematic illustration of a transverse cross section of the shock body of FIG. 1, in accordance with some embodiments.

FIG. 4 is a lengthwise cross section of a second perspective view of the shock body of FIG. 1, in accordance with some embodiments.

FIG. 5 is a schematic illustration of a lengthwise cross section of the shock body of FIG. 1, in accordance with some embodiments.

FIGS. 6A-C are schematic illustrations of exemplary embodiments of the shock body of FIG. 1, in accordance with some embodiments.

FIG. 7 illustrates an example computing environment for material additive manufacturing of a shock body, in accordance with some embodiments.

FIG. 8 illustrates a process for the material additive manufacturing of a shock body, in accordance with some embodiments.

### DETAILED DESCRIPTION

Before some particular embodiments are disclosed in greater detail, it should be understood that the particular embodiments disclosed herein do not limit the scope of the concepts provided herein. It should also be understood that a particular embodiment disclosed herein can have features that can be readily separated from the particular embodiment and optionally combined with or substituted for features of any of a number of other embodiments disclosed herein.

Regarding terms used herein, it should also be understood the terms are for the purpose of describing some particular embodiments, and the terms do not limit the scope of the concepts provided herein. Ordinal numbers (e.g., first, second, third, etc.) are generally used to distinguish or identify different features or steps in a group of features or steps, and do not supply a serial or numerical limitation. For example, “first,” “second,” and “third” features or steps need not necessarily appear in that order, and the particular embodiments including such features or steps need not necessarily be limited to the three features or steps. Labels such as “left,” “right,” “top,” “bottom,” “front,” “back,” and the like are used for convenience and are not intended to imply, for example, any particular fixed location, orientation, or direction. Instead, such labels are used to reflect, for example, relative location, orientation, or directions. Singular forms of “a,” “an,” and “the” include plural references unless the context clearly dictates otherwise.

The phrases “connected to,” “coupled with,” and “in communication with” refer to any form of interaction between two or more entities, including but not limited to mechanical, magnetic, fluid, and thermal interaction. Two components may be coupled to each other even though they are not in direct contact with each other. For example, two components may be coupled with each other through an intermediate component. Furthermore, two components that are described as connected to or coupled with each other does not imply that the two components at one time were not connected to or coupled with each other.

References to approximations may be made throughout this specification, such as by use of the term “substantially.” For each such reference, it is to be understood that, in some embodiments, the value, feature, or characteristic may be specified without approximation. For example, where qualifiers such as “about” and “substantially” are used, these terms include within their scope the qualified words in the absence of their qualifiers. For example, where the term “substantially straight” is recited with respect to a feature, it is understood that in further embodiments, the feature can have a precisely straight configuration.

Unless defined otherwise, all technical and scientific terms used herein have the same meaning as commonly understood by those of ordinary skill in the art.

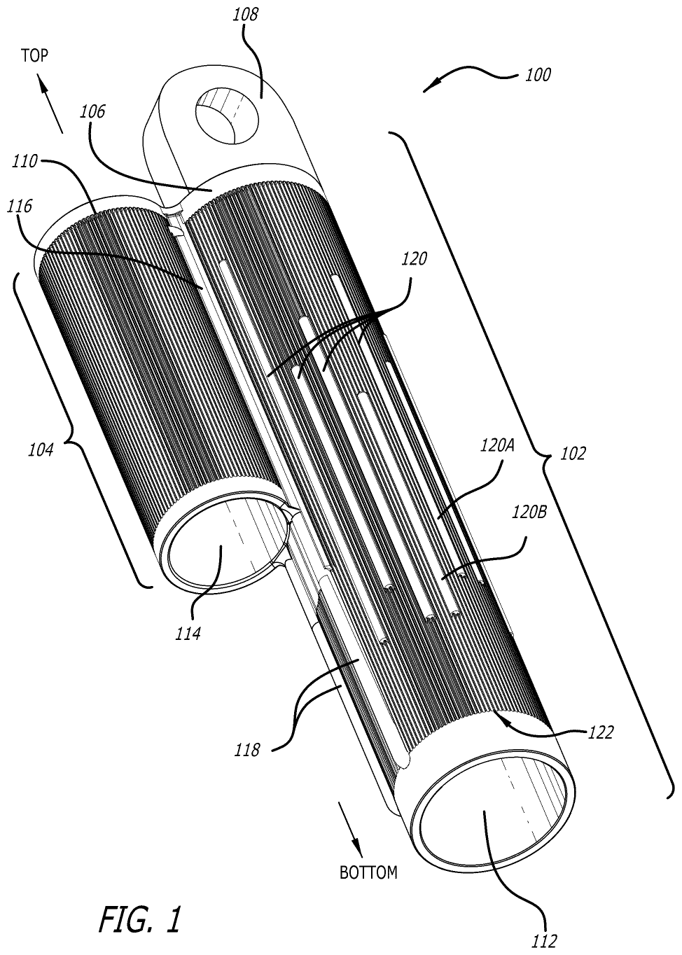

FIG. 1 is a first perspective view of a shock body 100, in accordance with some embodiments. Generally, a shock body 100 is configured to be combined with other components to form a shock absorber configured to damp the motion of a piece of equipment having mass, such as a vehicle for example. The shock body 100, when assembled with a number of functional components incorporated therein, forms a shock body assembly.

The shock body 100 generally defines a structural framework for the shock absorber. In various embodiments, the shock body 100 is formed of a single piece of material such that the shock body 100 itself is not an assembly of multiple components. The shock body 100 is formed of a single material throughout the entirety of the shock body 100, where the material may be a compound of more than one raw material. The shock body 100 is formed a material additive manufacturing process, sometimes referred to as three-dimensional (“3D”) printing. The material additive manufacturing process provides for the creation of features or shapes (e.g., under cuts) of the shock body 100 that are generally may be creatable via other conventional manufacturing process, such as machining, extruding, and the like. As such, conventional shock bodies generally include an assembly of multiple components. In some embodiments, the shock body 100 may be formed by a single continuous material additive manufacturing process. For the purpose of greater clarity of description herein, the shock body 100 is described as a combination of shock body components coupled together, but when referring to components of the shock body 100, “coupled together” or “coupled with each other” means integrally formed together via the material additive manufacturing process.

In some embodiments, materials used for the shock body 100 may include steel, steel alloy, titanium, aluminum, and/or aluminum alloy. In other embodiments, other materials such as non-metallic materials such as polylactic acid (PLA), reinforced nylon, or polyetheretherketone (PEEK). In some embodiments, the printing process utilized may be powder bed fusion printing, e.g., Direct Metal Laser Sintering (DMLS). Various DMLS printing machines may be utilized including machines having a single 200 w laser or machines having a plurality of lasers such as machines with 8 to 12 lasers ranging from 800-1200 w per laser. Other embodiments may utilize metal binder jet printing or Direct Energy Deposition.

The shock body 100 generally includes a cylinder 102 formed by a cylinder wall. In various embodiments, the shock body 100 also includes a reservoir 104 formed by a reservoir wall. For clarity and conciseness of description, the shock body 100 is generally described herein as including a cylinder 102 and a reservoir 104. The reservoir 104 has a reservoir top end 110 and a reservoir bottom end 114. As used herein, the reservoir top end 110 generally refers to the upper half of the reservoir 104, and the reservoir bottom end 114 generally refers to the bottom half of the reservoir 104. In embodiments where the reservoir 104 includes a separating member, as described in further detail below, the reservoir top end 110 generally refers to a portion of the reservoir 104 located above the separating member, and the reservoir bottom end 114 generally refers to a portion of the reservoir 104 located below the separating member. Similarly, the cylinder 102 has a cylinder top end and a cylinder bottom end 112. In embodiments where the cylinder 102 includes a piston, the cylinder top end generally refers to a portion of the cylinder 102 located above the piston, and the cylinder bottom end 112 generally refers to a portion of the cylinder 102 located below the piston.

During use, the cylinder 102 and the reservoir 104 contain hydraulic fluid. Although not required, one or both of the cylinder 102 and the reservoir 104 may be cylindrically shaped. In the illustrated embodiment, the cylinder 102 and reservoir 104 are oriented parallel with each other. In other embodiments, the cylinder 102 and reservoir 104 may be oriented relative to each other in a non-parallel relationship. The cylinder 102 and reservoir 104 are separated by a separation wall 116. The separation wall 116 may form a part of the cylinder wall of the cylinder 102 and/or reservoir wall of the reservoir 104.

Depending upon the embodiment, the separation wall 116 may include one or more fluid pathways through which hydraulic fluid may flow between the cylinder 102 and reservoir 104. For example, as illustrated in FIG. 1, the shock body 100 may include two reservoir fluid pathways 118. By way of the reservoir fluid pathways 118, fluid may flow between the cylinder bottom end 112 of the cylinder 102 and the reservoir top end 110 of the reservoir 104.

In other embodiments, the shock body 100 additionally or alternatively includes a transfer port extending across the separation wall 116 defining a fluid coupling between the cylinder 102 and the reservoir 104. When in use, hydraulic fluid flows back and forth between the cylinder 102 and reservoir 104 via the transfer port. In some embodiments, the transfer port may be located adjacent the cylinder top end and the reservoir top end, which location may enhance priming air bubbles from the hydraulic fluid.

The reservoir fluid pathways 118 extend along an exterior of the cylinder 102 and, depending upon the embodiment, may or may not pass through the separation wall 116. In some embodiments, the reservoir fluid pathways 118 are contained within the cylinder wall of the cylinder 102 and are not proud of the exterior surface of the cylinder wall of the cylinder 102.

The cylinder 102 and reservoir 104 are closed at the top via a body cap 106. In the illustrated embodiment, the body cap 106 includes an attachment member 108 coupled therewith. In other embodiments, the attachment member 108 may be coupled with another component of the shock body 101, such as the cylinder wall or the reservoir wall, for example. Each of the cylinder 102 and the reservoir 104 are open at the bottom. Generally, the end of the shock body 100 that includes the body cap 106 is referred to as the top (e.g., corresponding to the cylinder top end and the reservoir top end 110), and the open end of the shock body 100 opposite the body cap 106 is referred to as the bottom (e.g., corresponding to the cylinder bottom end 112 and reservoir bottom end 114). In an embodiment, the body cap 106 and the attachment member 108 are aspects of the same component, which may be additively manufactured in some embodiments.

The shock body 100 includes a set of bypass fluid pathways 120 that place the cylinder top end 110 in fluid communication with the cylinder bottom end 112. Via the bypass fluid pathways 120, fluid, such as hydraulic fluid, may flow between the cylinder top end 110 and the cylinder bottom end 112. Depending upon the embodiment, the shock body 100 may include any number of bypass fluid pathways 120, such as two, four, eight, sixteen, or twenty. As described in further detail below, the bypass fluid pathways 120 may vary in length or position on the cylinder wall of the cylinder 102. For example, a first bypass fluid pathway 120A and a second bypass fluid pathway 120B can differ in length and position along the cylinder wall of the cylinder 102. The first bypass fluid pathway 120A extends further towards the top of the shock body 100 along the cylinder wall of the cylinder 102 than does the second bypass fluid pathway 120B. However, the second bypass fluid pathway 120B extends further towards the bottom of the shock body 100 along the cylinder wall of the cylinder 102 than does the first bypass fluid pathway 120A. Furthermore, the first bypass fluid pathway 120A is longer than the second bypass fluid pathway 120B.

In some embodiments, some or all bypass fluid pathways 120 are partially or fully proud of the exterior surface of the cylinder wall of the cylinder 102. In other embodiments, some or all bypass fluid pathways 120 are contained within the cylinder wall of the cylinder 102 and are not proud of the exterior surface of the cylinder wall of the cylinder 102.

Depending upon the embodiment, the shock body 100 includes a raised cooling pattern proud of the exterior surface of the cylinder wall of the cylinder 102 and/or the exterior surface of the reservoir wall of the reservoir 104. In the embodiment of the figure, the raised cooling pattern is present upon the exterior surfaces of the cylinder wall of the cylinder 102 and the reservoir wall of the reservoir 104, and includes a multitude of straight cooling fins 122. Depending upon the embodiment, the raised cooling pattern can include one or more of straight cooling fins, curved cooling fins, jagged cooling fins, a cooling lattice mesh, a cooling gyroid mesh, and so on. The cooling lattice mesh may include a three-dimensional lattice pattern disposed upon the exterior surfaces of the cylinder 102. Similarly, the cooling gyroid mesh may include a three-dimensional gyroid pattern disposed upon the exterior surfaces of the cylinder 102.

The raised cooling pattern increases the surface area of the shock body 100 and thereby improves its cooling efficiency. Existing shock absorbers do not include a raised cooling pattern upon the exterior surfaces of the cylinder 102, and as such do not cool hydraulic fluid as efficiently as embodiments disclosed herein. For example, embodiments disclosed herein may yield approximately four times the heat transfer of conventional shock absorbers. As discussed below, conventional shock absorbers are formed using precision machining, extrusion, and welding techniques, which result in a wall thickness that does not support external cooling. For instance, many conventional shock absorbers formed using precision machining, extrusion, and welding techniques result in cylinder walls having a thickness of approximately 1.5-3 mm (0.060-0.120 inches) for steel-bodied cylinders, approximately 2.5-5 mm (0.100-0.200 inches) for aluminum-bodied cylinders, and approximately 3.175-6 mm (0.125-0.240 inches) for cylinders of shocks that are often referred to as “high-performance” or “off-road” shock absorbers. Thus, placement of a raised cooling pattern upon the exterior surfaces of conventional shock absorbers would have no cooling effect due to the cylinder wall thickness of such conventional shock absorbers. Differently, one improvement that is discussed in further detail below is the decreased cylinder (and optionally) reservoir wall thickness compared to conventional shock absorbers, which enables the raised cooling pattern to provide a cooling effect to the hydraulic fluid therein.

Furthermore, the integrated reservoir improves total conductive heat transfer through the shock body and directly into the reservoir cavity. This is because the design has more directly connected surface area as compared to conventional designs that rely on, for example, external conductive heat transfer only through an elbow piping. As the reservoir is integrated with the rest of the shock body, which is enabled through additive manufacturing, the common walls reduce mass and allow for a smaller overall package allowing for more end user freedom.

In one example, the integrated bypass circuits disclosed herein reduce mass as compared to prior art bypass circuits. For example, a max outer diameter (OD) of the shock body described herein may be is 3 inches, and is defined for consumers as a “3.0,” which follows the same naming convention current shock absorber manufacturers. However, current shock absorber manufacturer's actual measurements are larger, e.g., the max OD for prior art shocks are typically more than 3.75 inches because of how much space the conventional bypass fluid pathway takes. Embodiments of the present disclosure have a much smaller OD, which is preferable for end-users due to the reduced footprint of the shock absorber.

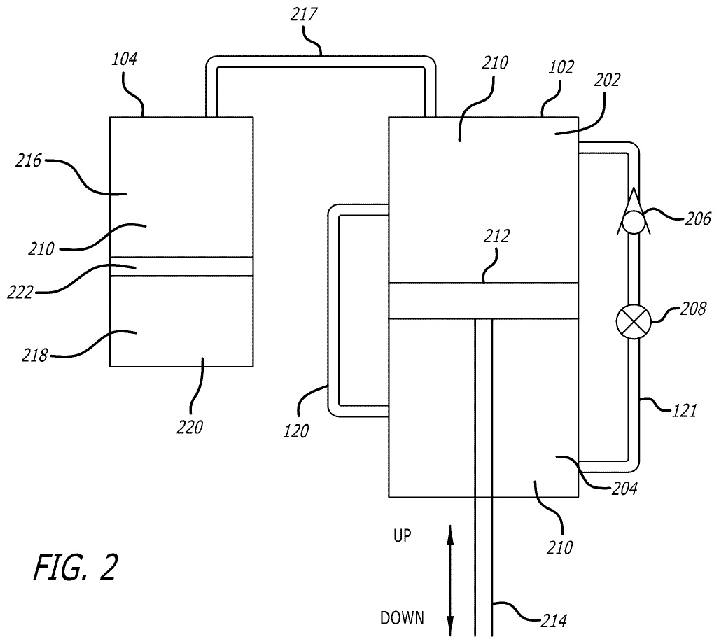

FIG. 2 is a fluid schematic illustration of a shock absorber including the shock body (otherwise “shock body assembly”) 100 of FIG. 1, in accordance with some embodiments. The shock absorber includes a piston 212 coupled with a shaft 214. A cylinder cap, through which the shaft 214 extends, may close off and seal the cylinder bottom end. The shaft 214 may slide up and down (e.g., in the direction of the top of the shock body 100 or in the direction of the bottom of the shock body). The shaft 214 may include a second attachment member that, when used in conjunction with the attachment member 108, can be configured to attach the shock absorber to a vehicle or other piece of equipment.

During use, the piston 212 travels up and down within the cylinder 102, e.g., according to forces applied to the shaft 214. The cylinder 102, both a cylinder top portion 202 corresponding to the cylinder top end (e.g., above the piston 212) and a cylinder bottom portion 204 corresponding to the cylinder bottom end (e.g., below the piston), is filled with hydraulic fluid 210. A reservoir top portion 216 corresponding to the reservoir top end (e.g., above a separating member 222) is also filled with hydraulic fluid 210. A reservoir bottom portion 218 corresponding to the reservoir bottom end (e.g., below the separating member 222) is filled with a pressurized gas 220, such as nitrogen. The separating member 222 seals the hydraulic fluid 210 from the pressurized gas 220, and may include a floating piston or a bladder that can move up or down within the reservoir 104.

The illustrated shock absorber includes a transfer port 217 placing the reservoir 104 and cylinder 102 in fluid communication. Although not illustrated, the shock absorber can include one or more reservoir fluid pathways 118. The shock absorber also includes a bypass fluid pathway 120 and an optional bypass fluid pathway 121. The figure includes one bypass fluid pathway 120 and one optional bypass fluid pathway 121 for clarity and conciseness, but the shock absorber can include any number of bypass fluid pathways 120 and/or optional bypass fluid pathways 121.

The optional bypass fluid pathway 121 includes two optional components which one or more bypass fluid pathways 120 of the shock absorber may include, depending upon the embodiment. Specifically, the optional bypass fluid pathway 121 includes a check valve 206 and an adjustable valve 208. Any number of bypass fluid pathways 120 may include any number of check valves 206, and any number of bypass fluid pathways may include any number of adjustable valves 208, depending upon the embodiment, and a bypass fluid pathway 120 may include a check valve 206 or adjustable valve 208 without necessarily including the other. Similarly, one or more reservoir fluid pathways 118 may include one or more check valves 206 and/or one or more adjustable valves 208, depending upon the embodiment. In an embodiment, the shock absorber does not include any check valves 206 or adjustable valves 208.

The check valve 206 is disposed in line with the optional bypass fluid pathway 121. The check valve 206 is configured to allow fluid flow along the optional bypass fluid pathway 121 in one direction and to prevent fluid flow along the optional bypass fluid pathway 121 in the other direction. For example, depending upon the embodiment, the check valve 206 may allow fluid flow from the cylinder bottom portion 204 to the cylinder top portion 202 only, or from the cylinder top portion 202 to the cylinder bottom portion 204 only. In some embodiments, the shock absorber includes multiple check valves 206, with one or more check valves 206 allowing fluid flow from the cylinder top portion 202 to the cylinder bottom portion 204 only, and one or more check valves 206 allowing fluid flow from the cylinder bottom portion 204 to the cylinder top portion 202 only.

The adjustable valve 208 is disposed in line with the optional bypass fluid pathway 121. The adjustable valve 208 is selectively adjustable by a user to define an adjustable restriction to a flow of hydraulic fluid. As an alternative to the first adjustable valve 138, the optional bypass fluid pathway 121 may include a flow restricting orifice (not shown) to provide a non-adjustable restriction to the flow of hydraulic fluid.

Traditional check valves were required to be manufactured in multiple parts and then assembled into a housing or pluming tube. As should be understood, the current methodology of manufacturing and assembling a check valve within a housing or pluming tube includes inefficiencies in time and materials as the multiple parts include material not utilized in the additive manufacturing process described herein (including wasted material and energy). The current methodology of manufacturing and assembling a check valve also introduces the possibility of error in assembly and/or manufacture (e.g., the parts may not be manufactured within a prescribed tolerance of the necessary measurements such that the parts to not fit together as desired).

One example of the type of check valve designed for the shock body of the disclosure is one where a ball is printed in free floating space that allows fluid to pass by when the fluid is flowing in a specific direction. Then when the direction of the fluid flow is reversed, due to change in direction of shock dampening piston, the ball is pushed by the fluid into a chamfered hole which checks the fluid from completing the fluid circuit. Other additively manufactured check valves may be utilized in some instances. In accordance with embodiments of the disclosure, the shock body and integrated check valve are designed so there is no need for any inaccessible supports or areas that require an acid bath in order to dissolve any low density supports to make the check valve functional. Such is another example of how the disclosure improves the efficiency of the manufacturing process of a shock body including a check valve.

One of the challenges of making a check valve is ensuring no leaks when the flow is checked. Referring to the current methodology of manufacturing and assembling a check valve, very high surface finishes are needed as well as seals or else leaks will occur. However, the methodology of the disclosure does not require the same tolerance with respect to seals. In the event that a leak occurs following printing of the check valve in accordance with embodiments of the disclosure, stopping the leak (or reducing to minimal or no interference or operability of the shock absorber assembly) may be performed through fine tuning of the valving of the shock dampener. Such is a different technique than shock dampeners manufactured and assembled using current techniques because the embodiments of the disclosure account for leakage at the valve enabling the shimming of pistons to reduce or stop the leak. In contrast, shock absorbers manufactured using current techniques are manufactured with zero tolerance for leakage at the valve, which results in more complex and costly manufacturing and assembly processes. As embodiments of the disclosure account for leakage (e.g., need not be manufactured with zero tolerance of valve leakage), the manufacturing of the novel shock absorbers disclosed here is simpler and less costly due at least in part to the use of additive manufacturing. This is advantageous as the machining/assembly complexity is reduced, which reduces overall cost and wasted material, and reduces the possibility of unfixable errors.

During operation, the piston 212 travels up and down within the cylinder 102. As the piston travels upward, the hydraulic fluid 210 flows along the bypass fluid pathway 120 and optional bypass fluid pathway 121 from the cylinder top portion 202 to the cylinder bottom portion 204. The adjustable valve 208 provides a restriction to the flow of the hydraulic fluid 210 along the optional bypass fluid pathway 121 to provide damping to the upward motion of the piston 212 (i.e., compression damping). The user may adjust the adjustable valve 208 to adjust the compression damping coefficient or amount. The narrow diameter of the bypass fluid pathway 120 similarly restricts the flow of the hydraulic fluid 210 along the bypass fluid pathway 120, and thereby provides damping to the upward motion of the piston 212.

As the piston 212 travels downward, the hydraulic fluid 210 flows along the bypass fluid pathway 120 and optional bypass fluid pathway 121 from the cylinder bottom portion 204 to the cylinder top portion 202. The check valve 206 prevents the hydraulic fluid 210 from flowing along the optional bypass fluid pathway 121 when the piston 212 travels downward. The restriction of fluid flow to the bypass fluid pathway 120 limits the fluid flow rate in proportion to the diameter of the bypass fluid pathway 120, damping the downward motion of the piston 212 (i.e., compression damping).

Depending upon the embodiment, the piston 212 may include a shim stack through which hydraulic fluid 210 may flow. The shim stack includes one or more thin, flexible metal shims that cover one or more ports in the piston 212. These shims flex and deflect based on hydraulic pressure, regulating fluid flow through the ports of the piston 212. The shim stack contributes to the shock absorber's hydraulic damping capabilities, and its sensitivity may be adjustable (e.g., by changing the number or type of shims in the stack).

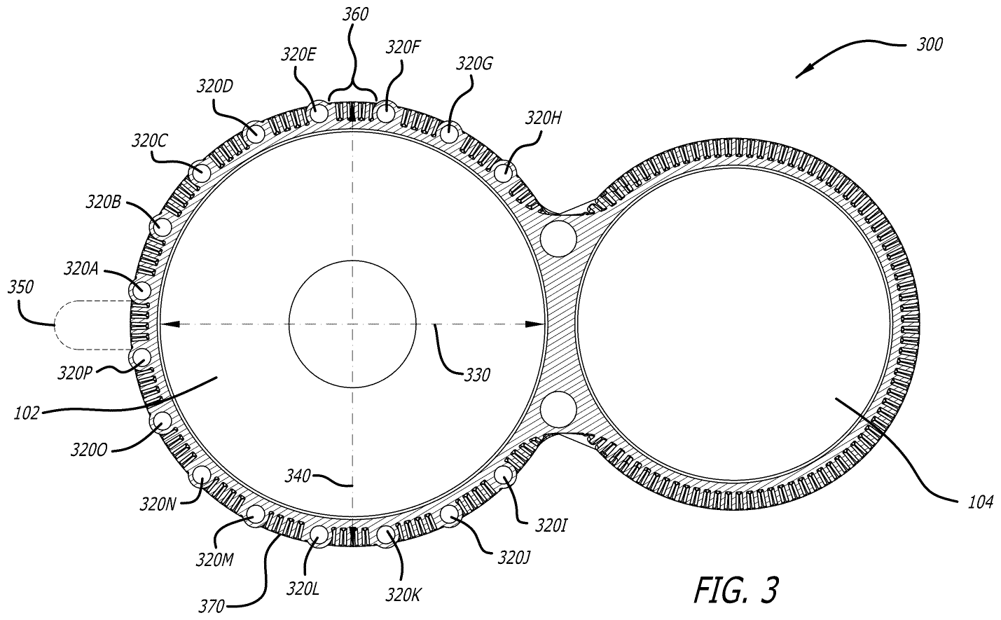

FIG. 3 is a schematic illustration of a transverse cross section 300 of the shock body assembly of FIG. 1, in accordance with some embodiments. The cross section 300 includes a cross section of the cylinder 102 and a cross section of the reservoir 104. The shock body 100 also includes bypass fluid pathway 320A-P cross sections. Although illustrated with sixteen bypass fluid pathways, the shock body may include any number of bypass fluid pathways, depending upon the embodiment. In some embodiments, the bypass fluid pathways 320A-P are equally spaced around the cylinder 102. In other embodiments, the bypass fluid pathways 320 are not equally spaced around the cylinder 102, but may be equally spaced across one or more sections of the circumference of the cylinder 102, or may be variably spaced.

As described in further detail below, the bypass fluid pathways 320 can be of varying length, depending upon the embodiment. For example, bypass fluid pathway 320B may be four inches long, and bypass fluid pathway 320L may be six inches long. By way of the bypass fluid pathways 320, hydraulic fluid can bypass flowing through the piston, reducing the overall damping effect. As described in further detail below, this can improve the smoothness of the damping effect provided by a shock absorber including the shock body assembly.

The size of the bypass fluid pathways 320 may depend on the embodiment, e.g., the inner diameter of one or more bypass fluid pathways 320 may vary. This can result in an adjustment of the dampening affect provided by the bypass fluid pathways 320. The cross section 300 also illustrates a cross section of an optional adjustable fluid pathway 350, which allows additional fine tuning of the total shock dampening provided by a shock absorber including the shock body. The adjustable fluid pathway 350 may include, for example, an adjustable valve as described above.

As illustrated, the shock body 100 does not include a bypass fluid pathway at location 360. In alternative embodiments, a bypass fluid pathway may be present at location 360. However, various embodiments do not include a bypass fluid pathway 320 at the location 360 to allow for tight clearance by the shock body 100 at the location 360, e.g., within a vehicle at an inboard position.

The shock body 100 includes a raised cooling pattern 370. The illustrated embodiment includes straight cooling fins, but as described herein, the raised cooling pattern 370 can by any of a variety of raised cooling patterns, depending upon the embodiment. The raised cooling pattern 370 is part of the external wall of the cylinder 102. Similarly, the bypass fluid pathways 320 are integral to the exterior wall of the cylinder 102. However, in some embodiments, the bypass fluid pathways 320 are partially or wholly proud of the external wall of the cylinder 102, e.g., extend outwards beyond the cylinder outer diameter 340. In some embodiments, the bypass fluid pathways 320 extend partially or wholly into the interior of the cylinder 102, e.g., extend within the cylinder inner diameter 330. However, this latter case is atypical at least because it increases the complexity of the piston. In an embodiment, the thickness of the exterior wall of the cylinder 102, including the raised cooling pattern 370, does not exceed 0.125 inches. This is less thick than in conventional shock absorbers, beneficially reducing the weight and size of the shock absorber. As discussed above, the thickness of the wall of the cylinder, excluding the raised cooling pattern, may be within a range of 0.508-1.27 mm (0.02-0.05 inches) with one specific embodiment being a thickness of 0.762 mm (0.03 inches). In some embodiments, the thickness of the raised cooling pattern is within a range of 1.905-3.175 mm (0.075-0.125 inches). The technological advantage including in the development and manufacturing of shock body assemblies according to the disclosure is that the use of additive manufacturing enables significant reduction in the wall thickness compared to that required when using precision machining, extrusion, and welding techniques as is done for the manufacture of current shock absorbers resulting in a greater wall thickness.

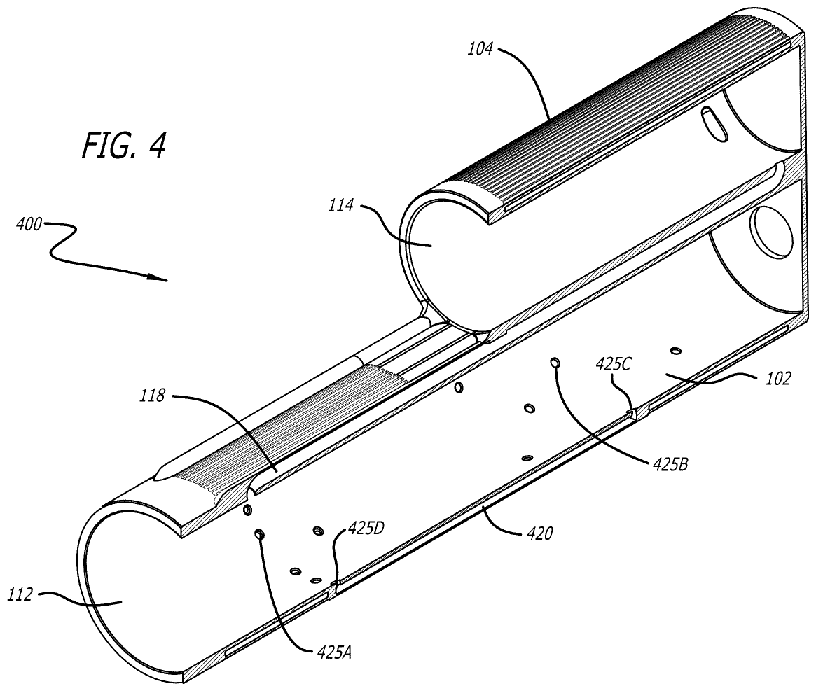

FIG. 4 is a lengthwise cross section 400 of a second perspective view of the shock body assembly of FIG. 1, in accordance with some embodiments. The lengthwise cross section 400 of the shock body 100 includes the cylinder 102 and the reservoir 104, which respectively have cylinder bottom end 112 and a reservoir bottom end 114. The lengthwise cross section 400 illustrates a reservoir fluid pathway 118, which puts in fluid communication the cylinder bottom portion with the reservoir top portion.

Also illustrated is a bypass fluid pathway 420, with bypass fluid pathway openings 425C-D. The bypass fluid pathway 420 is shorter than the reservoir fluid pathway 118, and connects the cylinder bottom end to the cylinder top end. The bypass fluid pathway 420, depending upon the embodiment, may be smaller in diameter than the reservoir fluid pathway 118. Bypass fluid pathway openings 425A-B lead to another bypass fluid pathway that may be different in length from bypass fluid pathway 420. Each bypass fluid pathway in the shock body has two bypass fluid pathway openings, one opening in a bottom portion of the cylinder and the other opening in a top portion of the cylinder.

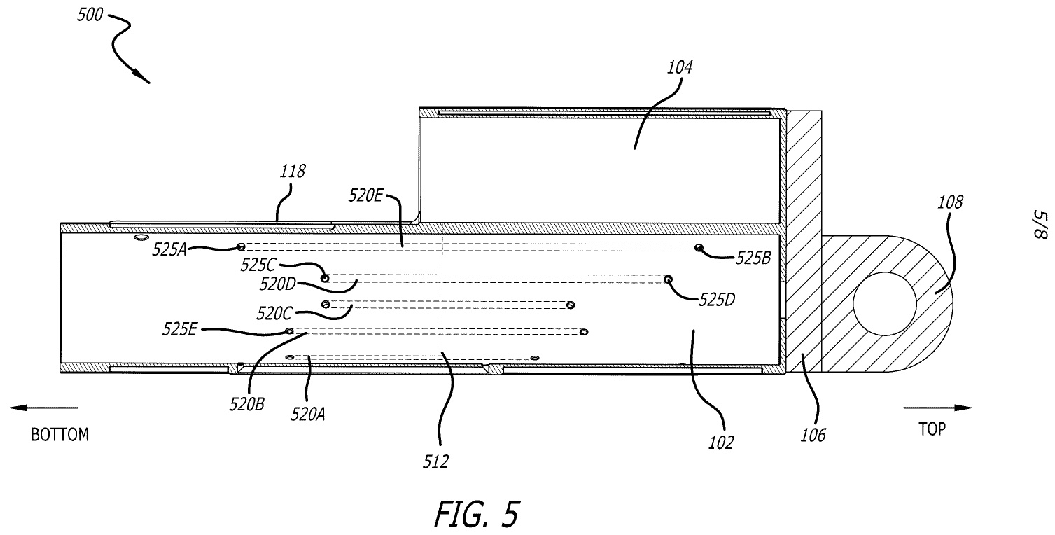

FIG. 5 is a schematic illustration of a lengthwise cross section 500 of the shock body assembly of FIG. 1, in accordance with some embodiments. The cross section 500 includes a view of the cylinder 102 and the reservoir 104. Part of a reservoir fluid pathway 118 is illustrated as part of the separating wall between the cylinder 102 and reservoir 104. At the top end of the shock body are the body cap 106 and attachment member 108.

Within the cylinder 102 is a piston resting position 512, bypass fluid pathways 520A-E, and bypass fluid pathway openings 525A-D. The piston resting position 512 indicates a position where the piston rests when the shock absorber is installed, e.g., within a vehicle, and is not actively damping. When in use, the piston has a maximum compression, e.g., movement towards the top of the shock body, and a maximum rebound, e.g., movement towards the bottom of the shock body. Depending upon the embodiment, the maximum compression location may be at the body cap 106, and the maximum rebound location may be a position near the bottom of the cylinder. For example, the maximum rebound location may be 1.5 inches above the bottom of the cylinder 102, according to one embodiment.

The bypass fluid pathways 520A-E indicate positions of bypass fluid pathways in the exterior wall of the cylinder 102. Similarly, the bypass fluid pathway openings 525A-D indicate positions of bypass fluid pathway openings corresponding to bypass fluid pathways 520. For example, bypass fluid pathway openings 525A-B correspond to the bypass fluid pathway 520E, bypass fluid pathway openings 525C-D correspond to the bypass fluid pathway 520D, and bypass fluid pathway opening 525E corresponds to the bypass fluid pathway 520B.

The bypass fluid pathways 520A-E vary in length along the cylinder 102. For example, bypass fluid pathway 520E is longer than bypass fluid pathway 520D. As such, when the piston compresses, initially, all the bypass fluid pathways 520 enable hydraulic fluid to flow from above the piston to below the piston. However, upon passing bypass fluid pathway opening 525D, the bypass fluid pathway 520D ceases to function for the flow of hydraulic fluid from above the piston to below the piston, because both bypass fluid pathway openings 525C-D are below the piston. As such, effectively, upon passing the bypass fluid pathway opening 525D, there are fewer bypass fluid pathways operating within the shock absorber. If the piston, when compressing, passes bypass fluid pathway opening 525B, then effectively the shock absorber has no bypass fluid pathways in operation at that moment.

When the piston rebounds from above the bypass fluid pathway opening 525B back towards the bottom of the piston, first the bypass fluid pathway 520E resumes functioning, then upon the piston passing bypass fluid pathway opening 525D, bypass fluid pathway 520D resumes functioning, and so on. Upon passing the piston resting position 512 in rebound towards the bottom of the cylinder 102, the piston first passes bypass fluid pathway opening 525C, ending the operation of bypass fluid pathway 520D at that moment. As the piston continues to rebound, eventually passing bypass fluid pathway opening 525A, then at that moment no bypass fluid pathways are in operation. In an embodiment, the piston does not rebound further towards the bottom of the cylinder 102 than the position of an opening of the reservoir fluid pathway 118.

As described above, when the piston first begins to move from the piston resting position 512, all bypass fluid pathways 520 are in operation, providing a maximum amount of fluid movement through bypass fluid pathways 520 rather than through the piston. This reduces the stiffness of the shock absorber, which is desirable for minor shocks that only slightly compress the piston. However, for larger shocks that more greatly compress the piston, as the piston compresses, it becomes stiffer due to fewer bypass fluid pathways 520 operating, eventually reaching maximum stiffness when the topmost bypass fluid pathway opening 525 has been passed. Similarly, as the piston rebounds, first each bypass fluid pathway 520 is in operation, reducing the stiffness of the shock absorber, but as the piston approaches a bottommost location within the cylinder 102, passing bypass fluid pathway openings in the bottom portion of the cylinder, the piston becomes more stiff. Overall, minor shocks are absorbed more smoothly, while the shock absorber provides maximum dampening for the largest shocks, which cause the greatest amount of compression of the piston.

Existing shock absorbers do not include a varied arrangement of bypass fluid pathways 520 as described herein, and do not provide benefits such as less stiff dampening for smaller shocks and stiffer dampening for larger shocks. Furthermore, because the bypass fluid pathways 520 are additively manufactured as part of the shock body, a distinct advantage over existing shock absorbers is provided, by reducing the number of components (as embodiments disclosed herein may consist of a single printed component). One advantage of the embodiments of this disclosure over current technology is the reduction in the number of components utilized in forming the shock body due at least in part to the use of additive manufacturing, which results in a reduction in the number of welding points. As a result, the likelihood of cracks, leaks, or other breakages is reduced. Another benefit provided by embodiments disclosed herein where bypass fluid pathways are disposed regularly or semi-regularly around the cylinder is a uniformity of pressure within the shock absorber, reducing the likelihood of a breakage. Yet another benefit is that shock bodies disclosed herein may be manufactured with a plurality of bypass zones, the number of which are not hindered by metering and tubing component placement, where more tubes and additional metering results in more manufacturing cost and an overall increase in the weight of a shock absorber.

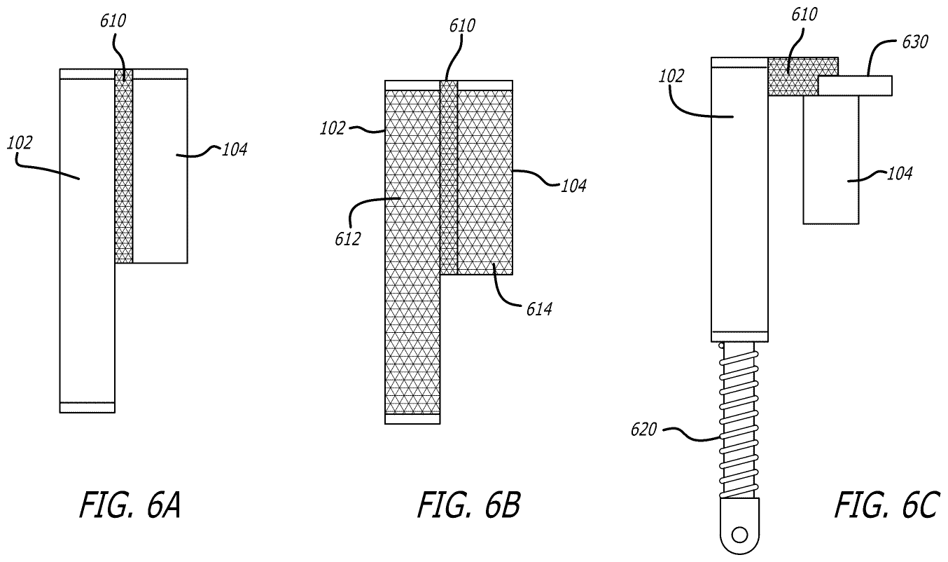

FIGS. 6A-C are schematic illustrations of exemplary embodiments of the shock body assembly of FIG. 1, in accordance with some embodiments. FIG. 6A illustrates one embodiment of a shock body assembly that includes a gyroid mesh bridge 610 separating the cylinder 102 from the reservoir 104. The gyroid mesh bridge 610 increases the total surface area of the shock body assembly, which improves its cooling efficiency. The gyroid mesh bridge 610 includes one or more fluid pathways connecting the cylinder 102 to the reservoir 104. The flow of fluid through the one or more fluid pathways within the gyroid mesh bridge 610 also improves the cooling efficiency of the shock body assembly. For example, the fluid pathways within the gyroid mesh bridge are directly in contact with the gyroid mesh bridge, rather than being separated from a raised cooling pattern by a cylinder wall or reservoir wall. As such, heat exchange from the hydraulic fluid to the gyroid mesh pattern is more efficient within the gyroid mesh bridge. Inclusion of the gyroid mesh bridge in the shock body assembly can also ease the finishing process when manufacturing the shock body assembly.

FIG. 6B illustrates one embodiment of a shock body assembly that includes a gyroid mesh bridge 610 separating the cylinder 102 from the reservoir 104, and also includes a gyroid mesh covering the cylinder 612 and a gyroid mesh covering the reservoir 614. The shock body assembly of FIG. 6B attains the same cooling efficiency benefits as the shock body assembly of FIG. 6A due to the gyroid mesh bridge 610, and also improves its cooling efficiency via the gyroid mesh 612, 614 covering the cylinder and reservoir cavity. The gyroid mesh 612, 614 further increase the surface area of the shock body assembly, further increasing its cooling efficiency. The gyroid mesh bridge 610, gyroid mesh 612, and gyroid mesh 614 may be one continuous gyroid mesh, or may be separate gyroid meshes.

FIG. 6C illustrates one embodiment of a shock body assembly that includes a gyroid mesh bridge 610 separating the cylinder 102 from the reservoir 104, and also includes a coilover spring 620 and adjustable valve 630. The coilover spring 620 is a coil spring enwrapping the shaft, providing additional damping. In other embodiments, the coilover spring 620 enwraps the shaft and part of the cylinder 102. In such embodiments, the gyroid mesh bridge 610 may not extend fully between the cylinder 102 and reservoir 104, instead connecting only a top portion of the cylinder 102 to a top portion of the reservoir 104, as illustrated in the figure. As such, a coilover spring 620 enwrapping part of the cylinder 102 can enwrap the cylinder 102 without also enwrapping the reservoir 104. The separation of the reservoir 104 from the cylinder 102 by the gyroid mesh bridge 610 creates a gap which may be occupied by the spring 620. The shock body assembly may also include an adjustable valve 630 that modulates the flow of hydraulic fluid between the cylinder 102 and the reservoir 104. The adjustable valve 630 may be mechanically or electronically adjusted, and may be manually, automatically, or semi-automatically controllable, depending upon the embodiment. In some embodiments, the cylinder 102 may include a raised cooling pattern as discussed throughout this disclosure even when the coilover spring 620 enwraps at least a portion of the cylinder 102.

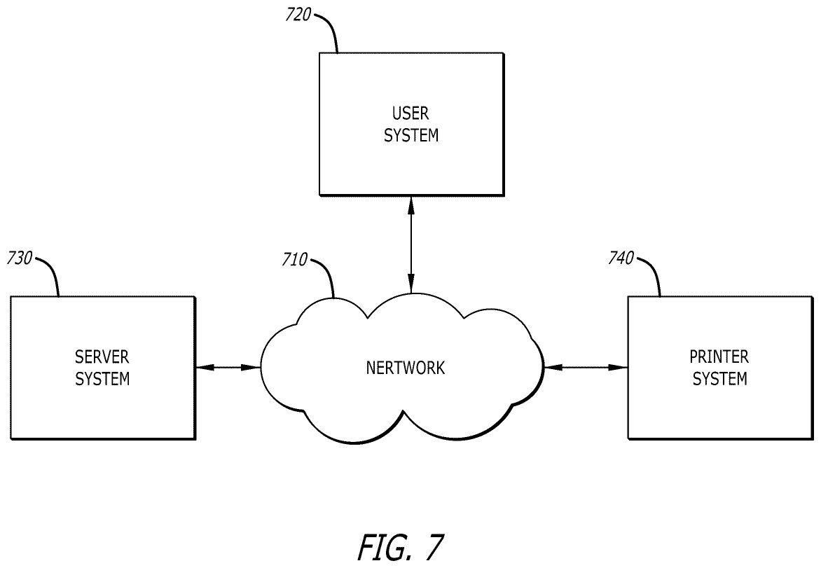

FIG. 7 illustrates an example computing environment for material additive manufacturing of a shock body assembly, in accordance with some embodiments. The illustrated example computing environment includes a network 710 connecting a user system 720, a server system 730, and a printer system 740. Depending upon the embodiment, the computing environment may include different or additional elements. For example, the computing environment may not include a server system 730 or may include multiple user systems 720 or printers 740. Furthermore, the functionality described herein may be distributed in a different manner than as described. For example, some or all functionality described herein with reference to the server system 730 may instead be provided by the user system 720, depending upon the embodiment.

The network 710 provides communication channels used by the other elements of the computing environment to communicate. The network 710 can include any combination of local area and/or wide area networks, using both wired and/or wireless communication systems. In one embodiment, the network 710 uses standard communications technologies and/or protocols. For example, the network 710 can include communication links using technologies such as Ethernet, 802.11, worldwide interoperability for microwave access (WiMAX), 3G, 4G, 5G, code division multiple access (CDMA), digital subscriber online (DSL), etc. Examples of networking protocols used for communicating via the network 710 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 710 may be represented using any suitable format, such as hypertext markup language (HTML) or extensible markup language (XML). All or some of the communication links of the network 710 may be encrypted using any suitable technique or techniques.

The user system 720 is one or more computing devices with which a user, such as an engineer, can design shock absorbers or components of shock absorbers, such as shock absorber body assemblies. The user system 720 may include software for designing, modeling, analyzing, and documenting physical objects, including shock absorbers and components of shock absorbers. For example, the software may be a computer-aided design (CAD) software program. Depending upon the embodiment, some or all functionality of the software may be hosted by the server system 730, which may provide an application programming interface (API) or portal accessed by the user system 720 and interacted with by a user of the user system 720 through a local software interface, such as a graphical user interface (GUI) of a CAD software program. In some embodiments, the software is hosted entirely locally on the user system 720.

The user system 720 receives user input for designing, modeling, analyzing, and documenting physical objects, and/or other user input for interacting with the software, at one or more input devices, such as a keyboard and a mouse. In some embodiments, the user system 720 includes one or more output devices, such as displays, presenting interfaces, such as GUIs of the software. Users design, model, analyze, document, and/or otherwise interact with software representing shock absorbers and/or shock absorber components using the user system 720, and send instructions to the printer system 740 using the user system 720. Depending upon the embodiment, sending the instructions to the printer system 740 employs functionality of the software for designing, modeling, analyzing and documenting physical objects, and/or employs software corresponding to the printer system 740, such as a software program of the printer system 740. In an embodiment, a user interacts with a CAD software program at the user system 720 to design, model, and/or analyze a digital design of a physical object, such as a shock absorber component (e.g., a shock body). The user uses the CAD software program to send instructions to software of the printer system 740, e.g., instructions to print a physical object according to the digital design.

The server system 730 is one or more computing systems, such as a group of servers, configured to host and expose access points to one or more software programs. For example, the server system 730 may host software for designing, modeling, analyzing, and documenting physical objects, remotely stored software of the user system 720, and/or software of the printer system 740. In some embodiments, the computing environment does not include a server system 730. In such embodiments, software is hosted at the user system 720 and/or printer system 740, such as a CAD software program at the user system 720, and a printer software program at the printer system 740.

The printer system 740 is an additive manufacturing device that performs additive manufacturing techniques to produce three-dimensional (3D) physical objects. Depending upon the embodiment, the printer system 740 may include more than one additive manufacturing device (also known as a “3D printer”), such as a set of additive manufacturing devices. The set of additive manufacturing devices may print different physical objects, or print different copies of the same physical object design, simultaneously. As mentioned above, the printer system 740 includes a software program governing operations of the printer system 740, e.g., operations of the additive manufacturing device.

The software program of the printer system 740 may be hosted by the user system 720, the server system 730, a different server system from the server system 730 hosting software for designing, modeling, analyzing, and documenting physical objects, and/or the printer system 740 itself. For example, the user system may include a software client for the printer system 740 that interacts with a printer software program hosted by the server system 730 and/or printer system 740. The software program of the printer system 740 receives instructions for printing physical objects and initiates an additive manufacturing session using the additive manufacturing device of the printer system 740 to create the physical object for which it received instructions to print.

The various software described above may include programs, such as software applications, as well as computer data, such as files, in one or more formats. Depending on the embodiment, some or all of the software and systems described with reference to FIG. 7 may perform operations relating to the designing, modeling, analyzing, documenting, and/or printing of physical objects, or to perform other functionality not explicitly described herein. For example, some or all of the software and systems described with reference to FIG. 7 may perform physical object design or modeling operations, physical object printing operations, and/or physical object analyzing operations, such as executing a surface area analysis and/or a thermal dissipation analysis of one or more digital models of physical objects designed or modeled using the software and systems.

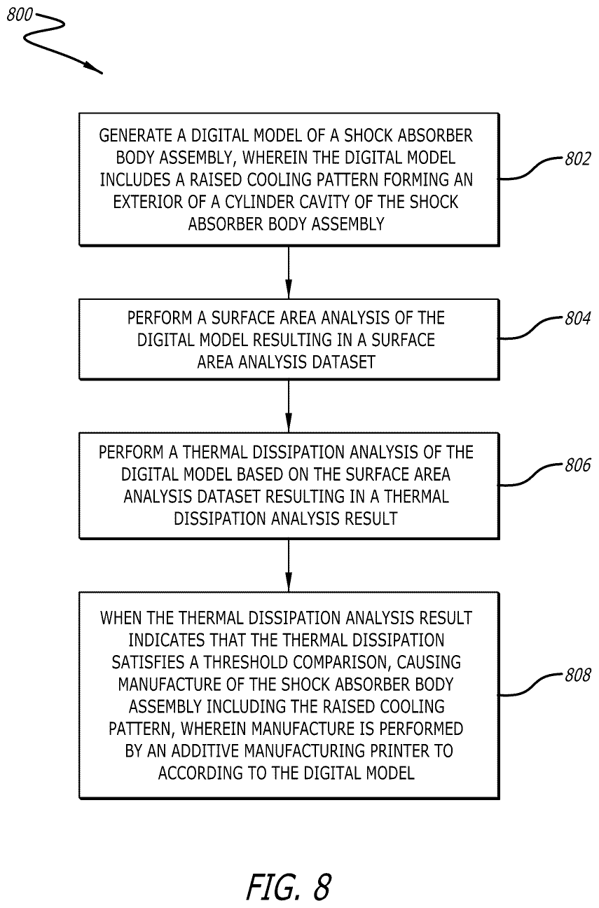

FIG. 8 illustrates a process for the material additive manufacturing of a shock body assembly, in accordance with some embodiments. The steps of FIG. 8 are illustrated from the perspective of the user system 720 performing the process. However, some or all of the steps may be performed by other entities or components. In addition, some embodiments may perform the steps in parallel, perform the steps in different orders, or perform different steps.

In the embodiment shown in FIG. 8, the process begins with the user system 720 generating 810 a digital model of a shock absorber body assembly, wherein the digital model includes a raised cooling pattern forming an exterior of a cylinder of the shock absorber body assembly. The digital model may be a CAD file, for example, which is produced by a user of the user system 720.

The user system 720 performs 820 a surface area analysis of the digital model, resulting in a surface area analysis dataset. In an embodiment, the user system 720 uses functionality of software local to the user system 720 to perform the surface area analysis. In other embodiments, the user system 720 accesses functionality of software at the server system 730 to perform the surface area analysis. The surface area analysis dataset may include a value indicating a total surface area of the digital model.

The user system 720 performs 830 a thermal dissipation analysis of the digital model based on the surface area analysis dataset, resulting in a thermal dissipation analysis result. Depending upon the embodiment, the user system 720 may use functionality of software local to the user system 720 and/or functionality of software at the server system 730 to perform the thermal dissipation analysis. In some embodiments, the thermal dissipation analysis may be based on the digital model and the surface area analysis results. The thermal dissipation analysis can involve modeling laws of physics, such as laws of thermodynamics, to produce the thermal dissipation analysis result.

When the thermal dissipation analysis result indicates that the thermal dissipation satisfies a threshold comparison, the user system 720 causes 840 manufacture of the shock absorber body assembly including the raised cooling pattern. Manufacturing the shock absorber body assembly is performed by an additive manufacturing printer according to the digital model. In an embodiment, causing 840 manufacture of the shock absorber body involves the user system 720 sending instructions to the printer system 740 to initiate manufacturing of the digital model.

In some embodiments, the thermal dissipation analysis result indicates that the thermal dissipation does not satisfy the threshold comparison. In such embodiments, the method includes revising the digital model, which may include altering the raised cooling pattern, performing a second surface area analysis of the revised digital model, and performing a second thermal dissipation analysis of the digital model based on a second surface area analysis dataset generated during performance of the second surface area analysis.

While some particular embodiments have been disclosed herein, and while the particular embodiments have been disclosed in some detail, it is not the intention for the particular embodiments to limit the scope of the concepts provided herein. Additional adaptations and/or modifications can appear to those of ordinary skill in the art, and, in broader aspects, these adaptations and/or modifications are encompassed as well. Accordingly, departures may be made from the particular embodiments disclosed herein without departing from the scope of the concepts provided herein.

What is claimed is:

1. A shock absorber body assembly, comprising:
a shock body, comprising:
a cylinder defining a top cylinder end and a bottom cylinder end, and
having a cylinder wall that surrounds a cylinder cavity,
wherein the cylinder wall is defined by a solid interior portion and a raised cooling pattern disposed on and proud of an exterior side of cylinder wall,
wherein the raised cooling pattern is comprised of one or more fins, wherein the raised cooling pattern is configured to provide for heat transfer from hydraulic fluid within the cavity of the cylinder cavity to an environment external to the shock absorber body assembly.

2. The shock absorber body assembly of claim 1, wherein the raised cooling pattern comprises one or more cooling fins that extend along a length of the cylinder in a straight line and extend outwardly from the cylinder wall in an orthogonal direction.

3. The shock absorber body assembly of claim 1, wherein the raised cooling pattern comprises a cooling lattice mesh or a cooling gyroid mesh.

4. The shock absorber body assembly of claim 1, wherein a thickness of the solid interior portion of the cylinder wall is within a range of 0.508-1.27 mm.

5. The shock absorber body assembly of claim 1, wherein a thickness of the raised cooling pattern is within a range of 1.905-3.175 mm.

6. The shock absorber body assembly of claim 1, wherein a thickness of the cylinder wall, including the solid interior portion and the raised cooling pattern, does not exceed 3.175 mm.

7. The shock absorber body assembly of claim 1, wherein the shock body is formed via a material additive manufacturing process.

8. The shock absorber body assembly of claim 7, wherein the shock body is formed of a single material.

9. The shock absorber body assembly of claim 1, wherein the cylinder forms a cavity that is configured to be partially filled with a hydraulic fluid, and wherein the first fluid pathway is configured to receive hydraulic fluid during operation of the shock absorber body assembly.

10. The shock absorber body assembly of claim 1, wherein the first fluid pathway includes a check valve, the check valve configured to allow hydraulic fluid flow in a first direction between the top portion of the cylinder and the bottom portion of the cylinder and prevent hydraulic fluid flow in a second direction between the top portion of the cylinder and the bottom portion of the cylinder, the second direction opposite the first direction.

11. The shock absorber body assembly of claim 1, wherein the shock body further comprises an adjustable fluid pathway, the adjustable fluid pathway comprising an adjustable valve disposed in line with the adjustable fluid pathway, the adjustable valve configured to adjustably limit hydraulic fluid flow along the adjustable fluid pathway between the top and bottom portions of the cylinder.

12. The shock absorber body assembly of claim 1, wherein the shock body includes a plurality of fluid pathways including the first fluid pathway, wherein each of the plurality of fluid pathways extend along the exterior of the cylinder, and
wherein each fluid pathway defines a respective first end of a respective fluid pathway in fluid communication with a top portion of the cylinder and a respective second end of a respective fluid pathway in fluid communication with a bottom portion of the cylinder.

13. The shock absorber body assembly of claim 12, wherein the plurality of fluid pathways are at least partially proud of the exterior of the cylinder.

14. The shock absorber body assembly of claim 12, wherein the first fluid pathway and a second fluid pathway of the plurality of fluid pathways have differing lengths, differing positions lengthwise along the exterior of the cylinder, or differing cross-sectional areas.

15. The shock absorber body assembly of claim 1, wherein the cylinder wall further includes at least a first fluid pathway extending along an exterior of the cylinder, wherein the first fluid pathway defines a first end of the first fluid pathway in fluid communication with a top portion of the cylinder and a respective second end of the first fluid pathway in fluid communication with a bottom portion of the cylinder, and wherein the first fluid pathway is at least partially proud of solid interior portion of the cylinder wall.

16. The shock absorber body assembly of claim 1, wherein the shock body further comprises a reservoir in fluid communication with the cylinder.

17. The shock absorber body assembly of claim 16, wherein the reservoir comprises a second raised cooling pattern, wherein the second raised cooling pattern comprises one or more of straight cooling fins, curved cooling fins, a cooling lattice mesh, or a cooling gyroid mesh, wherein the second raised cooling pattern is configured to provide for heat transfer from the hydraulic fluid within a cavity of the reservoir cavity to the environment external to the shock absorber body assembly.

18. The shock absorber body assembly of claim 1, wherein the shock absorber body assembly further comprises a coil spring enwrapping the cylinder.

19. The shock absorber body assembly of claim 1, wherein the shock absorber body assembly further comprises a body cap defining a top closure of the cylinder.

20. The shock absorber body assembly of claim 19, wherein the body cap comprises an attachment member configured to operably attach the shock absorber body assembly to a vehicle.
